(19) United States
(12) Patent Application Publication
(10) Pub. No.: US 2026/0182646 A1
(43) Pub. Date: Jul. 2, 2026

(54) AEROSOL GENERATING DEVICE

(71) Applicant: KT&G CORPORATION, Daejeon (KR)

(72) Inventors: Wonkyeong LEE, Daejeon (KR); Hunil LIM, Daejeon (KR); Jinsoo SEONG, Daejeon (KR)

(73) Assignee: KT&G CORPORATION, Daejeon (KR)

(21) Appl. No.: 19/338,461

(22) Filed: Sep. 24, 2025

(30) Foreign Application Priority Data
Dec. 30, 2024 (KR) 10-2024-0201132

(51) Int. Cl. A24F 40/46; A24F 40/10; A24F 40/51; A24F 40/57

(52) U.S. Cl. CPC A24F 40/46; A24F 40/10; A24F 40/51; A24F 40/57

(57) ABSTRACT

An aerosol generating device includes a housing including an accommodation space for accommodating at least part of an aerosol generating article, a circuit board located in the housing and configured to generate a radio frequency (RF) signal, a radiation unit located in the housing and configured to heat the aerosol generating article accommodated in the accommodation space by radiating the RF signal in the form of an electromagnetic wave toward the aerosol generating article, a material arranged adjacent to the accommodation space and configured to generate heat according to the radiated electromagnetic wave, and a controller configured to measure a temperature of the material and detect a temperature of the aerosol generating article based on a measured temperature of the material.

### CROSS-REFERENCE TO RELATED APPLICATION

This application is based on and claims priority under 35 U.S.C. § 119 to Korean Patent Application No. 10-2024-0201132, filed on Dec. 30, 2024, in the Korean Intellectual Property Office, the disclosure of which is incorporated by reference herein in its entirety.

### BACKGROUND

### 1. Field

The embodiments relate to an aerosol generating device, and more particularly, to an aerosol generating device that detects the temperature of an aerosol generating article using a material that generates heat together with the aerosol generating article.

### 2. Description of the Related Art

Recently, there has been an increasing demand for alternative methods that reduce disadvantages of general cigarettes. For example, there has been an increasing demand for a device (or an “aerosol generating device”) that generates an aerosol by heating an aerosol generating material (or an “aerosol generating article”) by using the aerosol generating device, instead of a method of generating an aerosol by burning a cigarette.

Conventionally, aerosol generating devices that heat an aerosol generating substance through a resistance heating method or an induction heating method have been commonly used, but recently, aerosol generating devices using a dielectric heating method that uses electromagnetic waves to heat an aerosol generating substance have also been proposed.

Aerosol generating devices using a dielectric heating method employs a method of vibrating a dielectric material within an aerosol generating substance through electromagnetic waves and heating the aerosol generating substance by using frictional heat generated from the vibration. Aerosol generating devices using a dielectric heating method may improve the uniformity of temperature distribution throughout an aerosol generating substance, and thus may improve aerosol generation efficiency and reduce thermal damage as compared to conventional heating methods, and are therefore attracting attention.

### SUMMARY

The technology for precisely controlling the temperature of an aerosol generating article is directly related to the quality of an aerosol, and accordingly, accurately measuring and controlling the temperature of an aerosol generating article is a critical issue.

Specifically, during an aerosol generation process, the temperature of an aerosol generating article determines the physical and chemical properties of the aerosol generating article, and accordingly, when temperature measurement and control of the aerosol generating article are inaccurate or unstable, the quality of an aerosol may be reduced, the performance of an aerosol generating device may be reduced, and user safety may also be adversely affected.

However, because the inner temperature of an aerosol generating article rapidly increases while the aerosol generating article is heated, attaching a temperature sensor to the aerosol generating article to directly detect the temperature of the aerosol generating article is difficult to implement due to the risk of damaging the temperature sensor.

The problems to be solved through the embodiments of the present disclosure are not limited to the problems described above, and problems not mentioned can be clearly understood by a person having ordinary skill in the art to which the embodiments belong from this specification and the attached drawings.

Additional aspects will be set forth in part in the description which follows and, in part, will be apparent from the description, or may be learned by practice of the presented embodiments of the disclosure.

An aerosol generating device according to an embodiment may include a housing including an accommodation space for accommodating at least part of an aerosol generating article, a circuit board located in the housing and configured to generate a radio frequency (RF) signal, a radiation unit located in the housing and configured to heat the aerosol generating article accommodated in the accommodation space by radiating the RF signal in the form of an electromagnetic wave toward the aerosol generating article, a material arranged adjacent to the accommodation space and configured to generate heat according to the radiated electromagnetic wave, and a controller configured to measure a temperature of the material and detect a temperature of the aerosol generating article based on a measured temperature of the material.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an aerosol generating device according to an embodiment;

FIG. 2 is a cross-sectional view of an aerosol generating device according to an embodiment;

FIG. 3 is a view illustrating an arrangement structure of a radiation unit of FIG. 2;

FIG. 4 is a cross-sectional view of an aerosol generating device according to another embodiment; and

FIG. 5 is a cross-sectional view of an aerosol generating device according to another embodiment.

### DETAILED DESCRIPTION

Hereinafter, embodiments will be described in detail with reference to the accompanying drawings, and the same or similar components will be assigned the same reference numerals regardless of the reference numerals in the drawings, and the same descriptions thereof will be omitted. With regard to the description of the drawings, like reference numerals may be used to represent like or related elements.

The suffixes “module”, “unit”, “-er”, and “-or” for the components used in the following description are given or used interchangeably by considering only the ease of writing the description, and do not have distinct meanings or roles in themselves. The suffix “module” or “unit”, as used herein, may include a unit implemented as hardware, software, or firmware. For example, the suffix “module” or “unit” may be interchangeably used with the term a “logic”, a “logical block”, a “component”, or a “circuit”. The “module” or “unit” may be an integrally formed component, a minimum unit of the component performing one or more functions, or a part of the minimum unit. For example, the “module” or “unit” may be implemented in the form of an application-specific integrated circuit (ASIC).

In addition, when describing the embodiments of the disclosure, the detailed description of the related known art, which may obscure the subject matter of the embodiments, may be omitted. Also, the accompanying drawings are only intended to facilitate understanding of the embodiments described herein, and the spirit of the disclosure is not limited by the accompanying drawings and should be understood to include all changes, equivalents or alternatives included in the spirit and scope of the disclosure.

Although the terms first, second, etc. may be used herein to describe various elements or components, these elements or components should not be limited by these terms. These terms are only used to distinguish one element or component from another element or component.

When an element is referred to as being “connected to” or “coupled to” another element, it may be directly connected or coupled to the other element or intervening elements may be present. In contrast, when an element is referred to as being “directly connected to” or “directly coupled to” another element, there are no intervening elements present.

The singular forms are intended to include the plural forms as well, unless the context clearly indicates otherwise.

Embodiments of the disclosure may be implemented as software including one or more instructions stored in a storage medium (for example, memory 17) that is readable by a machine (for example, an aerosol generating device 1). For example, a processor (for example, a controller 12) of the machine (for example, the aerosol generating device 1) may receive at least one of one or more commands stored in the storage medium and execute the command. This enables the machine to perform at least one function according to the at least one command. The one or more commands may include code generated by a compiler or code executable by an interpreter. The machine-readable storage medium may be provided in the form of a non-transitory storage medium. Here, “non-transitory” only means that a storage medium is a tangible device and does not include a signal (for example, an electromagnetic wave), and the term does not distinguish between a case where data is stored semi-permanently in a storage medium and a case where data is stored temporarily in the storage medium.

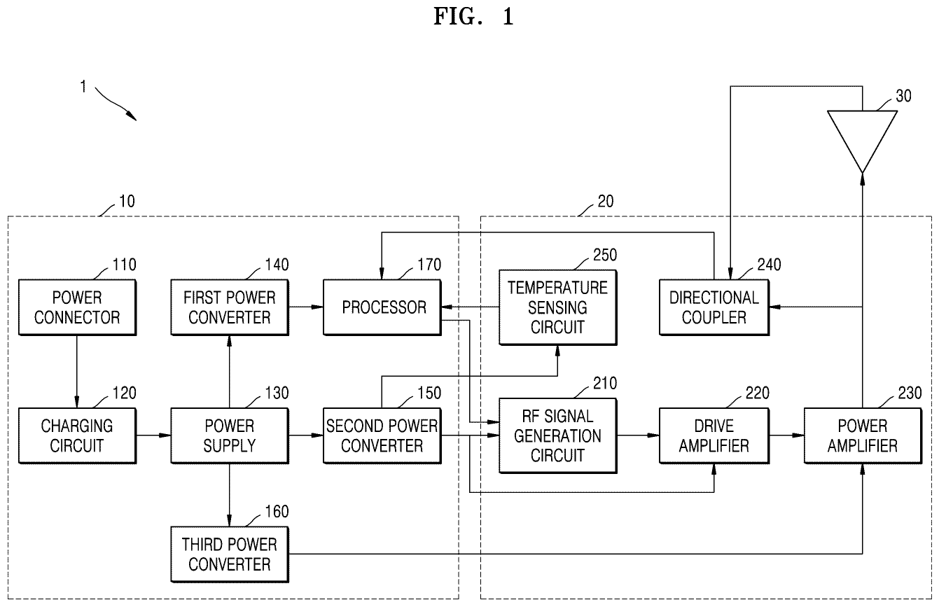

FIG. 1 is a block diagram of an aerosol generating device 1 according to an embodiment.

According to an embodiment, the aerosol generating device 1 may include a control unit 10, a source unit 20, and a radiating unit 30. The control unit 10 may refer to a circuit for controlling the basic operation of the aerosol generating device 1. The source unit 20 may refer to a circuit for generating a radio frequency (RF) signal under the control by the control unit 10. The radiating unit 30 may be a device for radiating an RF signal generated by the source unit 20 in the form of electromagnetic waves into a space into which an aerosol-generating article is inserted (hereinafter, “insertion space”). Charges or ions of a dielectric (e.g., glycerin) included in an aerosol-generating article may vibrate or rotate due to radiated electromagnetic waves (e.g., RF signals), and the aerosol-generating article may be heated as the dielectric generates heat due to frictional heat generated in the process of the charges or ions vibrating or rotating. In other words, the aerosol generating device 1 may be a device that generates an aerosol by heating an aerosol-generating article in a dielectric heating manner.

In an embodiment, the control unit 10 may include a power connector 110, a charging circuit 120, a power supply 130, a first power converter 140, a second power converter 150, a third power converter 160, and/or a processor 170. Additionally, the source unit 20 may include an RF signal generation circuit 210, a drive amplifier 220, a power amplifier 230, a directional coupler 240, and/or a temperature sensing circuit 250. However, it will be understood by those skilled in the art related to the present embodiment that some of the components illustrated in FIG. 1 may be omitted or new components may be added according to the design of the aerosol generating device 1.

The power connector 110 may refer to a physical connection device that is electrically connected to an electronic device or system (e.g., an external power supply) outside the aerosol generating device 1 and used to transmit and receive power. For example, the power connector 110 may receive power from an external power supply and transmit the received power to a component requiring charging (e.g., the power supply 130). The power connector 110 may also provide a path for data transmission. In this case, the power connector 110 may be referred to as a data and power connector. The aerosol generating device 1 may transmit and receive data to or from an external electronic device or system (e.g., a smartphone, a computer, etc.) through the power connector 110. The power connector 110 may include a Universal Serial Bus (USB) power connector, a direct current (DC) power connector, etc. In an example, the power connector 110 may include, but is not limited to, a USB-C type connector capable of supplying 9 V of direct current (DC) voltage at a current of 1 A. The power connector 110 may also include an interface for transmitting and receiving power wirelessly.

The charging circuit 120 may refer to a circuit for charging the power supply 130. The charging circuit 120 may charge the power supply 130 by using power transmitted from the power connector 110. In an example, the charging circuit 120 may be implemented as a charger IC, which is an integrated circuit (IC) that performs functions for efficiently and safely charging the power supply 130. The charging circuit 120 may monitor the charging status of the power supply 130 or optimize the charging process by monitoring the voltage, current, and/or temperature of the power supply 130. For example, the charging circuit 120 may detect the status of the power supply 130 and prevent overcharging or overdischarging by providing an appropriate charging voltage and current.

The power supply 130 may supply power for the operation of the aerosol generating device 1. The power supply 130 may include one or more rechargeable batteries. The power supply 130 may supply power to the radiating unit 30 such that the radiating unit 30 may radiate electromagnetic waves (e.g., RF signals) into the insertion space to heat an aerosol-generating article. Here, power supply to the radiating unit 30 may indicate power supply to the source unit 20. Additionally, the power supply 130 may supply power required for the operation of the processor 170, the RF signal generation circuit 210, the drive amplifier 220, the power amplifier 230, the temperature sensing circuit 250, etc. In an example, the power supply 130 may include, but is not limited to, a lithium polymer (LiPoly) battery. The power supply 130 may be a replaceable type (separated type) battery (hereinafter, a removable battery). The removable battery may be mounted in a battery holder provided within the aerosol generating device 1 or removed from the battery holder. The removable battery may be charged in a wired manner and/or wirelessly.

The aerosol generating device 1 may include a power conversion circuit for converting power supplied from the power supply 130 into power (e.g., voltage and/or current) suitable for other components. The power conversion circuit may include at least one of a buck converter, a buck-boost converter, a boost converter, a Zener diode, and a low-dropout (LDO) regulator. Additionally, the power conversion circuit may include a DC/AC converter (e.g., an inverter) as required.

In an example, the aerosol generating device 1 may include the first power converter 140, the second power converter 150, and the third power converter 160. The first power converter 140 may be an LDO regulator for supplying power (e.g., a DC of 3.3 V) suitable for the processor 170, the second power converter 150 may be a buck-boost converter for supplying power (e.g., a DC of 5 V) suitable for the temperature sensing circuit 250, the RF signal generation circuit 210, and the drive amplifier 220, and the third power converter 160 may be a boost converter for supplying power (e.g., a DC of 12 V/25 W) suitable for the power amplifier 230.

However, the first power converter 140, the second power converter 150, and the third power converter 160 are not limited to the examples described above and may include other types of power conversion circuits. Additionally, although FIG. 1 illustrates the aerosol generating device 1 including three power converters, the aerosol generating device 1 may include more than three power converters or may include fewer power converters. In an example, at least some of the first power converter 140, the second power converter 150, and the third power converter 160 may be integrated into a single power converter.

The processor 170 may control the overall operation of the aerosol generating device 1. For example, the processor 170 may directly or indirectly control charging and discharging of the power supply 130 by using the charging circuit 120. Additionally, the processor 170 may control the voltage and/or current output by a power conversion circuit by controlling the frequency and/or duty ratio of a current pulse input to at least one switching element of the power conversion circuit. In addition to the components described above, the processor 170 may also control the overall operation of other components to be described later.

The processor 170 may be implemented as an array of multiple logic gates, or may be implemented as a combination of a general-purpose microcontroller unit (MCU) (or microprocessor) and a memory storing a program that may be executed in the MCU. Additionally, it will be understood by those skilled in the art that the processor 170 may be implemented in other forms of hardware.

The RF signal generation circuit 210 may generate an RF signal based on power delivered from the power supply 130 or the second power converter 150. An RF signal may refer to a signal having a frequency within a range of about 300 MHz to about 300 GHz. In an example, the RF signal may have a frequency of about 1 GHz to about 100 GHz. Additionally, the RF signal may have a frequency in the Industrial Scientific and Medical equipment (ISM) band, for example, 915 MHz, 2.45 GHz, and/or 5.8 GHz.

The RF signal generation circuit 210 may include a voltage-controlled oscillator (VCO) that generates an RF signal having a different frequency depending on an input voltage. The RF signal generation circuit 210 may receive a control signal (e.g., a DC signal) from the processor 170 and generate an RF signal having a frequency corresponding to the received control signal. The processor 170 may store a control signal corresponding to a desired frequency in the form of a look-up table, or calculate a control signal corresponding to a desired frequency in real time through at least one operation.

In an example, the aerosol generating device 1 may further include a digital to analog converter (D/A converter) for converting a digital control signal output from the processor 170 into an analog control signal. The RF signal generation circuit 210 may receive the analog control signal and generate an RF signal having a frequency corresponding to the received analog control signal.

The drive amplifier 220 may amplify the RF signal generated by the RF signal generation circuit 210. For example, the drive amplifier 220 may provide an input signal suitable for a component of a next stage (e.g., the power amplifier 230) by amplifying the signal level (e.g., amplitude) of the RF signal. The drive amplifier 220 may minimize signal distortion by maintaining high linearity. However, since the drive amplifier 220 is an amplifier focused on increasing the signal level, the drive amplifier 220 may provide relatively low output power.

The power amplifier 230 may amplify power of an RF signal received from the drive amplifier 220. The power amplifier 230 may be an amplifier focused on providing sufficient power to a final output device (e.g., the radiating unit 30). For example, the power amplifier 230 may provide a high-power RF signal to the radiating unit 30 so that the radiating unit 30 may radiate electromagnetic waves into the insertion space to heat an aerosol-generating article. The power amplifier 230 may perform an amplification operation by using power received through the third power converter 160 that provides higher power and/or voltage than the second power converter 150.

The drive amplifier 220 and the power amplifier 230 may include transistors such as a bipolar junction transistor (BJT), a field effect transistor (FET), or a vacuum tube. In an example, the drive amplifier 220 and the power amplifier 230 may be, but are not limited to, gallium nitride (GaN) transistors configured to handle high efficiency, high speed, and high voltage. The drive amplifier 220 and the power amplifier 230 may also include an operational amplifier.

In FIG. 1, the drive amplifier 220 and the power amplifier 230 are illustrated as individual amplifiers, but the drive amplifier 220 and the power amplifier 230 may be integrated into a single amplifier. Additionally, the drive amplifier 220 and/or the power amplifier 230 may be configured as a series connection, a parallel connection, and/or a combination thereof of a plurality of amplifiers.

The radiating unit 30 may include at least one antenna for radiating electromagnetic waves into space. At least one antenna may have a size and shape suitable for the size and shape of an aerosol-generating article. For example, if the aerosol-generating article is cylindrical in shape, at least one antenna may be tubular surrounding the aerosol-generating article that is cylindrical. Here, the shape of the antenna being tubular may indicate that the overall shape of the antenna is tubular. In other words, if the antenna is formed of a metal (e.g., SUS) track, this may indicate that the overall shape of the entire track is tubular. The shape of at least one antenna is not limited to the examples described above and may include various shapes such as a flat plate shape, a curved plate shape, etc.

The radiating unit 30 may heat the aerosol-generating article by radiating electromagnetic waves (e.g., an amplified RF signal or a transmitted RF signal) into the insertion space. For the heating efficiency of the aerosol generating article to be maximized, resonance of electromagnetic waves is to occur within the insertion space. The resonance conditions (e.g., resonant frequency) of the insertion space may vary depending on the amount of dielectric contained in the inserted aerosol-generating article. The processor 170 may control the frequency of an RF signal generated by the RF signal generation circuit 210 to correspond to or be close to the resonance condition of the insertion space by adjusting a control signal input to the RF signal generation circuit 210. The processor 170 may use the directional coupler 240 to obtain information about the resonance conditions of the insertion space.

The directional coupler 240 may refer to a passive element having a waveguide structure that separates an incident wave and a reflected wave from each other. The directional coupler 240 may receive an RF signal transmitted from the power amplifier 230 toward the radiating unit 30 and electromagnetic waves reflected from the insertion space after they are radiated by the radiating unit 30. The directional coupler 240 may separate the transmitted RF signal and the reflected electromagnetic waves, and provide them to the processor 170.

In an example, the aerosol generating device 1 may further include an analog to digital converter (A/D converter) for converting an analog output of the directional coupler 240 into a digital output. The A/D converter may be built into the processor 170 or may exist as a separate component outside the processor 170. The processor 170 may analyze the characteristics (e.g., current, voltage, power, phase, and/or frequency) of the transmitted RF signal and the characteristics (e.g., current, voltage, power, phase, and/or frequency) of the reflected electromagnetic waves by monitoring the output of the directional coupler 240.

The processor 170 may determine whether the operation of the source unit 20 is being performed as intended, based on the characteristics of the transmitted RF signal. Additionally, the characteristics of the transmitted RF signal may be used to determine the heating efficiency of the source unit 20 or the radiating unit 30, together with the characteristics of the reflected electromagnetic wave. The processor 170 may control the source unit 20 such that the heating efficiency of the source unit 20 or the radiating unit 30 is maximized. For example, the processor 170 may adjust the frequency of an RF signal generated by the RF signal generation circuit 210 such that the power of the reflected electromagnetic waves is minimized. Minimizing the power of the reflected electromagnetic waves may indicate that the frequency of the RF signal is closer to the resonance conditions of the insertion space. The characteristics of the transmitted RF signal may provide a criterion for whether the power of the reflected electromagnetic waves is minimized.

Since resonance of electromagnetic waves may occur in the insertion space depending on the frequency of the RF signal, the insertion space may be referred to as a resonant section. At least a portion of the insertion space may be surrounded by at least one shielding member to prevent electromagnetic waves from leaking outside the aerosol generating device 1. In an embodiment, the insertion space may further include a physical structure to ensure that the resonance conditions are within a range controllable by the processor 170. The physical structure may include at least one conductor, and the resonance conditions of the insertion space may vary depending on the arrangement, thickness, and length of the conductor. Additionally, the physical structure may include a space for accommodating a dielectric having low electromagnetic absorption, separate from the dielectric contained in the aerosol-generating article. A dielectric with low electromagnetic absorption may change the resonant frequency of the entire resonant section without absorbing the energy that are to be transferred to the heated material. Accordingly, even if the resonant section is reduced in size, the resonance conditions may be determined within a range controllable by the processor 170.

The temperature sensing circuit 250 may be arranged in contact with or adjacent to components included in the source unit 20 to measure the temperature of the source unit 20. For example, the temperature sensing circuit 250 may be arranged in contact with or adjacent to at least one of the RF signal generation circuit 210, the drive amplifier 220, and the power amplifier 230. Heat may be generated due to limited efficiency in the process of generating and/or amplifying RF signals, and if excessive heat is generated, this heat may have a negative impact on components included in the source unit 20 or other components included in the aerosol generating device 1. The temperature measured by the temperature sensing circuit 250 may be used to prevent overheating of the source unit 20.

The processor 170 may receive the temperature (or a value corresponding to the temperature) measured from the temperature sensing circuit 250, and if it is determined that the source unit 20 is overheated, the processor 70 may stop the operation of the source unit 20. For example, the processor 170 may stop the operation of the source unit 20 by cutting off the power supply to the source unit 20 or transmitting a control signal. Hereinafter, the term ‘power supply’ to the source unit 20 is used to indicate controlling whether the source unit 20 operates.

The temperature sensing circuit 250 may include at least one temperature sensor among a thermocouple, a resistance temperature detector (RTD), a thermistor, a semiconductor temperature sensor, and an optical temperature sensor. In an example, the temperature sensing circuit 250 may be implemented as a chip-type sensor (e.g., a negative temperature coefficient (NTC) sensor) to minimize the area occupied, but is not limited thereto.

The aerosol generating device 1 may include other components in addition to the components illustrated in FIG. 1. For example, the aerosol generating device 1 may further include a sensor unit, an output unit, an input unit, a communication unit, and a memory. In addition, if the aerosol generating device 1 is a hybrid type device that uses both an aerosol-generating article and a cartridge, the aerosol generating device 1 may further include a cartridge heater. The cartridge heater may receive power from the power supply 130 to heat a medium and/or an aerosol-generating material within the cartridge.

According to an embodiment, the sensor unit may detect the status of the aerosol generating device 1 or the status around the aerosol generating device 1 and transmit the detected information to the processor 170. For example, the sensor unit may include a temperature sensor, a puff sensor, an insertion detection sensor, a reuse detection sensor, an overly moist detection sensor, a cigarette identification sensor, a cartridge detection sensor, a cap detection sensor, and/or a motion detection sensor. The sensor unit may further include various sensors, such as a liquid remaining amount sensor for detecting the remaining liquid amount of the cartridge, and an immersion sensor for detecting immersion of the aerosol generating device 1.

In an embodiment, the temperature sensor may detect the temperature of the insertion space or the aerosol-generating article. The temperature sensor may be positioned in contact with or adjacent to the insertion space or the aerosol-generating article to directly measure the temperature of the insertion space or the aerosol-generating article. Additionally, the temperature sensor may be positioned to be spaced apart from the insertion space or the aerosol-generating article to indirectly measure the temperature of the insertion space or the aerosol-generating article (e.g., in a non-contact manner). In an example, the temperature sensor may include an optical temperature sensor (e.g., an infrared temperature sensor).

In an embodiment, the temperature sensor may detect the temperature of the power supply 130. The temperature sensor may be arranged adjacent to the power supply 130. For example, the temperature sensor may be attached to one surface of the power supply 130 (e.g., a battery) and/or mounted on one surface of a printed circuit board. For example, the aerosol generating device 1 may include a protection circuit module (PCM), and the temperature sensor may be positioned adjacent to the power supply 130 together with the PCM.

According to an embodiment, the temperature sensor may be arranged inside the housing (not shown) of the aerosol generating device 1 to detect the temperature inside the housing (not shown).

In an embodiment, the puff sensor may detect a user's puff.

As an example, the puff sensor may include a pressure sensor. The pressure sensor may output a signal corresponding to the internal pressure of the aerosol generating device 1, and the processor 170 may detect a user's puff based on the signal corresponding to the internal pressure. The internal pressure of the aerosol generating device 1 may correspond to pressure of an airflow path on which gas flows. The puff sensor may be disposed to correspond to the airflow path, through which gas flows, in the aerosol generating device 1.

In another example, the puff sensor may include a temperature sensor. When a user puffs, a temporary temperature drop may occur in the airflow path, the insertion space, the aerosol generating article, etc. The processor 170 may detect the user's puff based on a signal corresponding to the temperature of an airflow path, etc. output from a temperature sensor.

In another example, the puff sensor may include both a pressure sensor and a temperature sensor. In this case, the temperature sensor may measure the temperature which is used to correct the internal pressure measured by the pressure sensor. For example, the puff sensor may correct a signal corresponding to internal pressure based on a temperature measured by the temperature sensor and output the corrected signal. In another example, the puff sensor may output a signal corresponding to a temperature measured by the temperature sensor and a signal corresponding to the internal pressure measured by the puff sensor. In this case, the processor 170 may receive the signals and correct the signal corresponding to the internal pressure, based on the signal corresponding to the temperature.

In another example, the puff sensor may include a capacitance-based sensor. In the disclosure, the capacitance-based sensor may also be referred to as a capacitive sensor. When a user puffs, temperature changes and/or aerosol flow may occur within the insertion space, thereby changing the permittivity within the insertion space. The processor 170 may detect the user's puff based on a signal corresponding to the permittivity inside the insertion space output from the capacitive sensor.

The puff sensor is not limited to the examples described above and may be implemented with various sensors to detect the user's puff.

In an embodiment, the insertion detection sensor may detect insertion and/or removal of an aerosol-generating article. The insertion detection sensor may be installed around the insertion space.

As an example, the insertion detection sensor may include a capacitive sensor. The capacitive sensor may include at least one conductor, wherein the at least one conductor may be positioned adjacent to the insertion space. When an aerosol generating article is inserted or removed within the insertion space, the permittivity around the conductor may change. The processor 170 may detect insertion and/or removal of an aerosol-generating article based on a signal corresponding to the permittivity inside the insertion space output from the capacitive sensor.

In another example, the insertion detection sensor may include an inductive sensor. The inductive sensor may include at least one coil, wherein the at least one coil may be positioned adjacent to the insertion space. When an aerosol-generating article (e.g., a wrapper for the aerosol-generating article) contains a conductor, a change in the magnetic field may occur around the current-carrying coil when the aerosol-generating article is inserted into or removed from the insertion space. The processor 170 may detect insertion and/or removal of an aerosol-generating article including a conductor based on characteristics of a current output from or detected by an inductive sensor (e.g., frequency of an alternating current, current value, voltage value, inductance value, impedance value, etc.). Alternatively, the aerosol-generating article (e.g., the medium portion of the aerosol-generating article) may include a susceptor (e.g., SUS). Even in this case, a change in the magnetic field around the coil may occur based on the insertion or removal of a susceptor or the like within the insertion space, and the processor 170 may also detect the insertion and/or removal of the aerosol-generating article based on the characteristics of the current of the inductive sensor.

The insertion detection sensor is not limited to the examples described above and may be implemented using various sensors (e.g., proximity sensors, etc.) for detecting insertion and/or removal of an aerosol-generating article. Additionally, the insertion detection sensor may include any combination of the examples described above. In an embodiment, the insertion detection sensor may include a switch or the like for detecting compression by an aerosol-generating article.

In an embodiment, the reuse detection sensor may detect whether an aerosol-generating article has been reused. As an example, the reuse detection sensor may be a color sensor for detecting the color of the aerosol generating article. When the aerosol-generating article is used by a user, a change in color of a portion of the wrapper surrounding the outside of the aerosol-generating article may occur due to the generated aerosol or heating. The color sensor may output a signal corresponding to optical characteristics (e.g., wavelength of light) corresponding to the color of the wrapper based on light reflected from the wrapper. The processor 170 may determine that the aerosol-generating article inserted into the insertion space has already been used if a change in color of a portion of the wrapper is detected.

In an embodiment, the overly moist detection sensor may detect whether the aerosol-generating article is overly moist. For example, the overly moist detection sensor may include a capacitive sensor. The capacitive sensor may include at least one conductor positioned adjacent to the insertion space. The processor 170 may detect whether the aerosol-generating article is overly moist, based on the level of a signal corresponding to a permittivity or the like output from the capacitive sensor. For example, the processor 170 may determine a level range within which the level of the signal is included, based on a look-up table, and determine the moisture content of the aerosol-generating article based on the determined level range.

In an embodiment, the cigarette identification sensor may detect whether the aerosol-generating article is authentic and/or detect the type of the aerosol-generating article.

As an example, the cigarette identification sensor may include an optical sensor for detecting an identification material (or identification tag) located on an outer surface of an aerosol-generating article (e.g., a wrapper). The optical sensor may irradiate light toward the identification material (or identification mark) of the aerosol-generating article and detect, based on the reflected light, the authenticity and/or type of the aerosol-generating article. For example, the identification material may include a material that emits light of a particular wavelength, based on the irradiated light. The processor 170 may detect whether the aerosol-generating article is authentic and/or the type of the article based on the range of the wavelength.

In another example, the cigarette identification sensor may include a capacitive sensor. Depending on the type of aerosol generating article inserted into the insertion space, the permittivity inside the insertion space may vary. The processor 170 may detect whether the aerosol generating article is authentic and/or the type thereof based on a signal corresponding to the permittivity inside the insertion space output from the capacitive sensor.

In another example, the cigarette identification sensor may include an inductive sensor. When a conductor is included in a wrapper and/or interior (e.g., medium portion) of an aerosol-generating article inserted into the insertion space, the characteristics of the current detected by the inductive sensor (e.g., frequency of AC current, current value, voltage value, inductance value, impedance value, etc.) may differ depending on the type of the aerosol-generating article inserted into the insertion space. The processor 170 may detect whether the inserted aerosol-generating article is authentic and/or the type thereof based on the characteristics of the current output from or detected by the inductive sensor.

The cigarette identification sensor is not limited to the examples described above and may be implemented using various sensors to detect whether the aerosol-generating article is authentic and/or to detect the type of the aerosol-generating article. Additionally, the cigarette identification sensor may include any combination of the examples described above.

In an embodiment, the cartridge detection sensor may detect mounting and/or removal of a cartridge. For example, the cartridge detection sensor may include an inductive sensor, a capacitive sensor, a resistive sensor, a hall sensor (hall IC) and/or an optical sensor.

In an embodiment, the cap detection sensor may detect attachment and/or removal of a cap. For example, the cap detection sensor may include an inductive sensor, a capacitive sensor, a resistive sensor, a contact sensor, a hall sensor (hall IC) and/or an optical sensor. The cap may include a structure that covers at least a portion of a cartridge mounted or inserted into the aerosol generating device 1, or covers at least a portion of the housing of the aerosol generating device 1. The cap detection sensor may output a signal corresponding to the mounting or removal of the cap when the cap is mounted on or removed from the housing, and the processor 170 may detect the mounting or removal of the cap based on the signal corresponding to the mounting or removal.

According to an embodiment, the motion detection sensor may detect movement of the aerosol generating device 1. The motion detection sensor may be implemented using at least one of an acceleration sensor or a gyro sensor.

According to an embodiment, the sensor unit may further include, in addition to the sensors described above, at least one of a humidity sensor, an atmospheric pressure sensor, a magnetic sensor, a position sensor (global positioning system (GPS)), or a proximity sensor. The functions of the sensors would be instinctively understood by one of ordinary skill in the art in view of their names and thus detailed descriptions thereof are omitted herein.

According to an embodiment, the output unit may output information about the status of the aerosol generating device 1. The output unit may include, but is not limited to, a display, a haptic unit, and/or an audio output unit. For example, information about the aerosol generating device 1 may include the charging/discharging status of the power supply 130 of the aerosol generating device 1, the operating status of the source unit 20 or the radiating unit 30, the insertion/removal status of the aerosol-generating article and/or cartridge, the mounting and/or removal status of the cap, or the status in which the use of the aerosol generating device 1 is limited (e.g., detection of an abnormal article). The display may visually provide information to the user about the status of the aerosol generating device 1. For example, the display may include a light-emitting diode (LED) light emitting element, a liquid crystal display (LCD) panel, an organic light-emitting diode (OLED) display panel, etc. The display, if the display includes a touchpad, may also be used as an input device. The haptic unit may provide tactile information to the user about the status of the aerosol generating device 1. For example, the haptic component may include a vibration motor, a piezoelectric element, an electrical stimulation device, and the like. The audio output unit may provide information about the aerosol generating device 1 to the user audibly. For example, the audio output unit may convert an electrical signal into an audio signal and output the same externally.

According to an embodiment, the input unit may receive information input from a user. For example, the input unit may include a touch panel, a button, a key pad, a dome switch, a jog wheel, a jog switch, and the like.

According to an embodiment, the memory may be hardware that stores various data processed within the aerosol generating device 1, and may store data processed by the processor 170 and data to be processed. For example, the memory may include at least one type of storage medium among a flash memory type, a hard disk type, a multimedia card micro type, a card type memory (e.g., an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. For example, the memory may store data about the operation time of the aerosol generating device 1, the maximum number of puffs, the current number of puffs, at least one temperature profile, and the user's smoking pattern.

According to an embodiment, the communication unit may include at least one component for communicating with another electronic device (e.g., a portable electronic device). For example, the communication unit may include a Bluetooth communication unit, a Bluetooth Low Energy (BLE) communication unit, a near field Communication unit, a wireless local area network (WLAN) communication unit, a Zigbee communication unit, an infrared (Infrared Data Association (IrDA)) communication unit, a wireless fidelity direct (WFD) communication unit, a ultra-wideband (UWB) communication unit, an Adaptive Network Topology (ANT)+communication unit, a cellular network communication unit, an Internet communication unit, a computer network (e.g., LAN or WAN) communication unit, etc.

According to an embodiment, the processor 170 may control the temperature of the insertion space or the aerosol-generating article by controlling an amplification factor of the source unit 20 (e.g., the power amplifier 230). The processor 170 may control the amplification factor of the source unit 20 (e.g., the power amplifier 230) based on the temperature of the insertion space or the aerosol-generating article detected using the temperature sensor. The processor 170 may control the amplification factor of the source unit 20 (e.g., the power amplifier 230) based on the temperature profile and/or power profile stored in the memory.

Additionally, the processor 170 may control the temperature of the cartridge heater by controlling the supply of power from the power supply 130 to the cartridge heater. The processor 170 may control the temperature of the cartridge heater and/or power supplied to the cartridge heater, based on the temperature of the cartridge heater detected using the temperature sensor. The processor 170 may control the temperature of the cartridge heater and/or the power supplied to the cartridge heater based on the temperature profile and/or power profile stored in the memory.

In an embodiment, the processor 170 may prevent the insertion space, the aerosol-generating article, and/or the cartridge heater from overheating. For example, the processor 170 may control the operation of the power conversion circuit to reduce the amount of power supplied to the source unit 20 or the cartridge heater, or to stop supplying power to the source unit 20 or the cartridge heater, based on a determination that temperature of the insertion space, the aerosol-generating article, and/or the cartridge heater exceeds a preset threshold temperature.

According to an embodiment, the processor 170 may control power supply to the source unit 20 or the cartridge heater, based on a result detected by the sensor unit.

In an embodiment, the processor 170 may control power supply to the source unit 20 or the cartridge heater based on insertion and/or removal of the aerosol-generating article into the insertion space. For example, the processor 170 may control power to be supplied to the source unit 20 or the cartridge heater when it is determined that the aerosol-generating article has been inserted into the insertion space using the insertion detection sensor. The processor 170 may cut off the power supply to the source unit 20 or the cartridge heater if it is determined that the aerosol-generating article has been removed from the insertion space using the insertion detection sensor. The processor 170 may determine that the aerosol-generating article has been removed from the insertion space, if the temperature of the insertion space or the aerosol-generating article is above a limited temperature or if the temperature change gradient of the insertion space or the aerosol-generating article is equal to or above a set gradient.

In an embodiment, the processor 170 may control the power supply time and/or power supply amount of power supplied to the source unit 20 or the cartridge heater, based on the state of the aerosol-generating article. For example, the processor 170 may increase the power supply time (e.g., preheating time) of power supply to the source unit 20 or the cartridge heater, if it is determined that the aerosol-generating article is in an overly moist state by using the overly moist detection sensor.

In an embodiment, the processor 170 may control power supply to the source unit 20 or the cartridge heater based on whether the aerosol-generating article is to be reused. For example, the processor 170 may cut off power supply to the source unit 20 or the cartridge heater if it is determined that the aerosol-generating article has been used.

In an embodiment, the processor 170 may control power supply to the source unit 20 or the cartridge heater, based on whether the cartridge is engaged and/or removed. For example, the processor 170 may stop supplying power to the source unit 20 or the cartridge heater or control power not to be supplied to the source unit 20 or the cartridge heater if it is determined, by using the cartridge detection sensor, that the cartridge is removed.

In an embodiment, the processor 170 may control power supply to the source unit 20 or the cartridge heater based on whether the aerosol-generating material in the cartridge has been exhausted. For example, the processor 170 may determine that the aerosol-generating material in the cartridge is exhausted if it is determined that the temperature of the cartridge heater exceeds a limit temperature while preheating the cartridge heater (i.e., during the preheating period). If it is determined that the aerosol-generating material in the cartridge has been exhausted, the processor 170 may cut off the supply of power to the source unit 20 or the cartridge heater.

In an embodiment, the processor 170 may control power supply to the source unit 20 or the cartridge heater based on the availability of the cartridge. For example, the processor 170 may determine that the cartridge is no longer usable if it is determined that the current number of puffs is equal to or greater than the maximum number of puffs set for the cartridge based on data stored in the memory. Alternatively, the processor 170 may determine that the cartridge is unusable if the total time that the cartridge heater has been heated is equal to or greater than a preset maximum time or the total amount of power supplied to the cartridge heater is equal to or greater than a preset maximum amount of power. In this case, the processor 170 may stop supplying power to the source unit 20 or the cartridge heater or control power not to be supplied to the source unit 20 or the cartridge heater.

In an embodiment, the processor 170 may control power supply to the source unit 20 or the cartridge heater based on the user's puff. For example, the processor 170 may use a puff sensor to determine whether a puff has occurred and/or the intensity of the puff. The processor 170 may cut off the power supply to the source unit 20 or the cartridge heater if the number of puffs reaches a preset maximum number of puffs and/or if no puffs are detected for a preset period of time. The processor 170 may also control the supply of power to the source unit 20 or the cartridge heater when a puff is detected.

In an embodiment, the processor 170 may control power supply to the source unit 20 or the cartridge heater based on the authenticity and/or type of the aerosol-generating article (or the cartridge). For example, the processor 170 may use the cigarette identification sensor to detect the authenticity and/or type of the aerosol-generating article (or the cartridge). For example, the processor 170 may cut off power supply to the source unit 20 or the cartridge heater if the aerosol-generating article (or the cartridge) is detected to be counterfeit. The processor 170 may control (e.g., initiate) the supply of power to the source unit 20 or the cartridge heater when the aerosol-generating article (or the cartridge) is detected to be authentic. In another example, the processor 170 may control power supply to the source unit 20 or the cartridge heater differently depending on the type of the aerosol-generating article (or the cartridge). The processor 170 may control the amplification factor of the source unit 20 or the temperature and/or power of the cartridge heater, based on a first temperature profile (or a first power profile) when the aerosol-generating article (or the cartridge) is detected to be a first aerosol-generating article (or a first cartridge), and may control the amplification factor of the source unit 20 or the temperature and/or power of the cartridge heater, based on a second temperature profile (or a second power profile) when the aerosol-generating article (or the cartridge) is detected to be a second aerosol-generating article (or a second cartridge).

According to an embodiment, the processor 170 may control the output unit based on a result detected by the sensor unit. For example, the processor 170 may control the output unit to provide visual, tactile and/or auditory information indicating that the aerosol generating device 1 is about to be terminated, when the number of puffs counted using the puff sensor reaches a preset number. For example, the processor 170 may control the output unit to provide visual, tactile and/or auditory information about the temperature of the insertion space, the aerosol-generating article, or the cartridge heater.

According to an embodiment, the processor 170 may store and update a history of events that occurred in the memory based on the occurrence of a given event. For example, the event may include operations such as detection of insertion of an aerosol-generating article, initiation of heating of an aerosol-generating article, detection of a puff, termination of a puff, detection of overheating, detection of overvoltage application to a cartridge heater, termination of heating of an aerosol-generating article, turning on/off power of the aerosol generating device 1, initiation of charging of the power supply 130, detection of overcharge of the power supply 130, termination of charging of the power supply 130, etc., performed in the aerosol generating device 1. For example, the history of events may include the time an event occurred, log data corresponding to the event, etc. For example, if a given event is detection of insertion of an aerosol-generating article, log data corresponding to the event may include data about sensing values of an insertion detection sensor, etc. For example, if a given event is overheating detection of a cartridge heater, log data corresponding to the event may include data about a temperature of the cartridge heater, a voltage applied to the cartridge heater, a current flowing through the cartridge heater, etc.

According to an embodiment, the processor 170 may control the communication unit to form a communication link with an external device, such as a user's mobile terminal.

According to an embodiment, the processor 170 may release a restriction on the use of at least one function (e.g., a heating function) of the aerosol generating device 1 when data regarding authentication is received from an external device via a communications link. For example, data regarding authentication may include the user's date of birth, a unique number that identifies the user, whether the user has completed authentication, etc.

According to an embodiment, the processor 170 may transmit data about the status of the aerosol generating device 1 to an external device via a communication link (e.g., remaining capacity of the power supply 130, operating mode, etc.). The transmitted data may be output through a display of an external device, etc.

According to an embodiment, when a request for location search of the aerosol generating device 1 is received from an external device via a communication link, the processor 170 may control the output unit to perform an operation corresponding to the location search. For example, the processor 170 may control the haptic unit to generate vibration or control the display to output an object corresponding to the location search and search termination.

According to an embodiment, the processor 170 may perform a firmware update when firmware data is received from an external device via a communication link.

According to an embodiment, the processor 170 may transmit data on sensed values of at least one sensor unit to an external server (not shown) via a communication link, and receive and store a learning model generated by learning the sensed values through machine learning, such as deep learning, from the server. The processor 170 may perform operations such as determining a user's inhalation pattern and generating a temperature profile using a learning model received from a server.

Although not illustrated in FIG. 1, the aerosol generating device 1 may further include a power protection circuit. The power protection circuit may include at least one switching element and may cut off the current path to the power supply 130 in response to overcharge and/or overdischarge of the power supply 130.

An aerosol-generating article as described herein may include at least one aerosol-generating rod (e.g., a medium portion) and at least one filter rod. The radiating unit 30 may be arranged to correspond to at least one aerosol-generating rod, and may be designed differently depending on the arrangement order and/or position of the aerosol-generating rod and the filter rod. The aerosol-generating rod may include at least one of nicotine, an aerosol-generating material, and an additive. For example, the aerosol-generating material may include glycerin (e.g., vegetable glycerin (VG)) and/or propylene glycol (PG), and may also include various other materials. For example, the additive may include flavoring agents and/or organic acids, and may also include various other substances. For example, the aerosol-generating rod may include an aerosol-generating substrate (e.g., a sheet) impregnated with a liquid non-tobacco material (e.g., an aerosol-generating material and/or nicotine), and/or may include a solid tobacco material (e.g., leaf tobacco, reconstituted tobacco, etc.). The tobacco material may be included in the aerosol-generating rod in various forms, such as cut tobacco, granules, or powder. In an embodiment, the additive of the aerosol-generating rod may include a basic substance. Based on the basic material, the nicotine of the tobacco material included in the aerosol-generating rod may have an alkaline pH (e.g., pH 7.0 or higher). In this case, freebase nicotine may be released from the aerosol-generating rod even at low temperatures. According to an embodiment, the aerosol-generating rod may include two or more aerosol-generating rods, wherein the two or more aerosol-generating rods may each include tobacco material and/or non-tobacco material. Although not shown, at least one aerosol-generating rod and at least one filter rod may be individually and/or integrally wrapped by at least one wrapper. In the disclosure, the aerosol-generating article may be referred to as a stick.

The cartridge referred to in the disclosure may include an aerosol-generating material having any one of a liquid state, a solid state, a gaseous state, or a gel state therein. The aerosol-generating material may include a liquid composition. For example, the liquid composition may be a liquid including a tobacco-containing material including a volatile tobacco flavor component, or may be a liquid including a non-tobacco material. The cartridge may include a storage portion containing an aerosol-generating material and/or a liquid transfer means impregnated with (containing) the aerosol-generating material. For example, the liquid transfer medium may include a wick such as cotton fibers, ceramic fibers, glass fibers, porous ceramics, etc. The cartridge heater may be included in the cartridge in the form of a coil surrounding (or winding) the liquid transfer means or in a structure contacting one side of the liquid transfer means. Alternatively, the cartridge heater may be included in the aerosol generating device 1 that is separable from the cartridge.

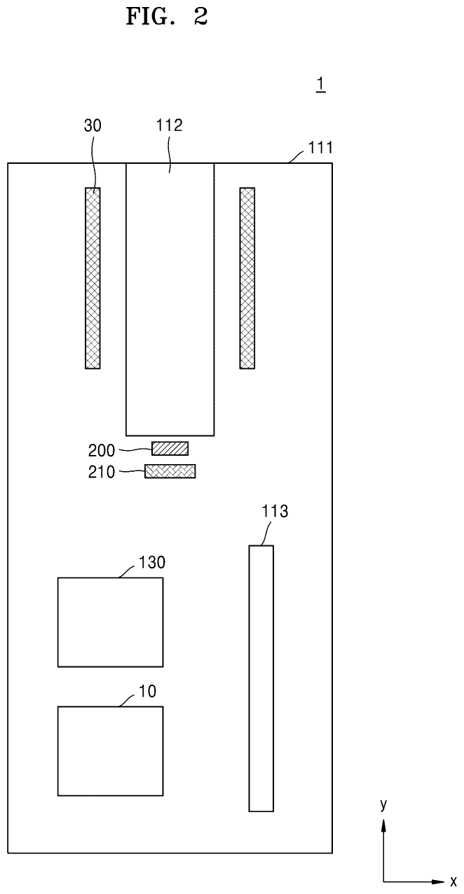

FIG. 2 is a cross-sectional view of an aerosol generating device 1 according to an embodiment.

Referring to FIG. 2, the aerosol generating device 1 (for example, the aerosol generating device 1 of FIG. 1) according to an embodiment may include a housing 111, a circuit board 113, a radiation unit 30, a material 200, a power supply 130 (for example, the power supply 130 of FIG. 1), and a controller 10 (for example, the controller 10 of FIG. 1). However, FIG. 2 illustrates only the components necessary to describe the present embodiment, but components of the aerosol generating device 1 are not limited thereto. Depending on embodiments, some of the illustrated components may be omitted, or new components may be added thereto.

The housing 111 may include an accommodation space (or an insertion space) 112 for accommodating or being inserted with at least part of an aerosol generating article, and may form the entire structure of the aerosol generating device 1. Components of the aerosol generating device 1 may be arranged in an inner space of the housing 111.

For example, the circuit board 113, the radiation unit 30, the power supply 130, the controller 10, the material 200, and a temperature sensor 210 may be arranged in the inner space of the housing 111. However, the components of the aerosol generating device 1 arranged in the inner space of the housing 111 are not limited thereto. In another example, memory (not illustrated) may also be arranged in the inner space of the housing 111.

The circuit board 113 may generate an RF signal. For example, the circuit board 113 may include an RF signal generation circuit (for example, the RF signal generation circuit 210 of FIG. 1). Accordingly, the circuit board 113 may generate an RF signal when power is supplied to the circuit board 113. However, a circuit included in the circuit board 113 is not limited thereto.

The circuit board 113 may further include a drive amplifier (for example, the drive amplifier 220 of FIG. 1), a power amplifier (for example, the power amplifier 230 of FIG. 1), a directional coupler (for example, the directional coupler 240 of FIG. 1), and/or a temperature sensing circuit (for example, the temperature sensing circuit 250 of FIG. 1). In this case, the circuit board 113 may receive power, generate an RF signal, and amplify the generated RF signal. For example, the circuit board 113 may amplify a signal level (for example, amplitude) and/or power of the generated RF signal.

The radiation unit 30 may radiate an RF signal generated by the circuit board 113 in the form of electromagnetic wave toward an aerosol generating article accommodated in the accommodation space 112. The radiation unit 30 may be electrically or operatively connected to the circuit board 113 and may radiate electromagnetic waves (for example, microwaves) toward the accommodation space 112 in response to the RF signal supplied from the circuit board 113. For example, the radiation unit 30 may surround an outer circumferential surface of the accommodation space 112 and may radiate electromagnetic waves toward an aerosol generating article accommodated in the accommodation space 112.

The radiated electromagnetic waves may cause the electric charges or ions of a dielectric (for example, glycerin) included in an aerosol generating article to vibrate or rotate to generate frictional heat, and accordingly, the aerosol generating article may be heated by the frictional heat to generate an aerosol. For example, the vapor generated by heating an aerosol generating article may be mixed with external air flowing into the accommodation space 112 through a gap between the accommodation space 112 and the aerosol generating article or an airflow passage (not illustrated), and thereby, an aerosol may be generated.

The material 200 may generate heat in response to electromagnetic waves. For example, the material 200 may generate heat when exposed to the electromagnetic waves radiated from the radiation unit 30. In other words, the material 200 may absorb electromagnetic energy of the electromagnetic waves radiated from the radiation unit 30 and reaching the material 200 and converts the electromagnetic energy into thermal energy.

The material 200 may have permittivity that is the same as or similar to the permittivity of an aerosol generating article. For example, the aerosol generating article may include vegetable glycerin. The vegetable glycerin may generate frictional heat when exposed to microwaves of approximately 2.45 GHz, and accordingly, an aerosol generating article including the vegetable glycerin may be heated. Because the material 200 has the same permittivity as vegetable glycerin, the material 200 may dissipate heat in response to microwaves of approximately 2.45 GHz, similar to vegetable glycerin.

The material 200 may include at least one of ferrite, a carbon-based material, metal, metal oxide, and a dielectric material. For example, the material 200 may include at least one of nickel-zinc (Ni—Zn) ferrite and manganese-zinc (Mn—Zn) ferrite. In this case, the material 200 may absorb a change in magnetic field caused by electromagnetic energy of the radiated electromagnetic waves and convert the change in magnetic field into thermal energy.

However, the type of the material 200 is not limited to the examples described above. In another example, the material 200 may include at least one of carbon black, carbon nanotubes (CNTs), and graphene. In this case, the material 200 may convert the dielectric loss and conductive loss generated by interacting with an electric field component of the radiated electromagnetic wave into thermal energy.

In another example, the material 200 may be metal or metal nanoparticles based on at least one of iron (ferrous material), nickel, and cobalt. Alternatively, the material 200 may be a metal oxide including at least one of manganese oxide (MnO₂), titanium oxide (TiO₂), and nickel oxide (NiO). Alternatively, the material 200 may be a material in which a carbon-based material is mixed with at least one of ferrite, metal, and a metal oxide.

In another example, the material 200 may include at least one of barium titanate (BaTiO₃) and silicon carbide (SiC). In this case, the material 200 may convert the high dielectric loss resulting from interaction with an electric field component of the radiated electromagnetic wave into thermal energy.

The material 200 may be arranged adjacent to the accommodation space 112. For example, the material 200 may be outside the accommodation space 112 to be in contact with at least part of the accommodation space 112 or may be close to the accommodation space 112.

The electromagnetic waves radiated from the radiation unit 30 toward the accommodation space 112 may be transmitted mostly to an aerosol generating article, but some of the electromagnetic waves may also be transmitted to the material 200 adjacent to the accommodation space 112. Accordingly, an aerosol generating article and the material 200 may be simultaneously heated by the electromagnetic waves radiated from the radiation unit 30.

For example, when microwaves of approximately 2.45 GHz are radiated from the radiation unit 30 toward the accommodation space 112 to heat vegetable glycerin included in an aerosol generating article, the aerosol generating article and the material 200 exposed to the microwaves of approximately 2.45 GHz may generate heat together.

In this case, there may be a linear correlation between a temperature of the aerosol generating article heated by the same microwave and a temperature of the material 200 heated by the same microwave. For example, when exposed to the same microwave, there may be a one-to-one correspondence between the temperature of the aerosol generating article and the temperature of the material 200.

Although not illustrated, the aerosol generating device 1 according to an embodiment may further include memory. The memory may store a correlation between a temperature of the aerosol generating article and a temperature of the material 200. For example, the memory may store a lookup table in which a temperature of the aerosol generating article matches a temperature of the material 200.

The power supply 130 may supply power for operating the aerosol generating device 1. For example, the power supply 130 may be electrically or operatively connected to the circuit board 113 and the radiation unit 30 to supply the necessary power thereto. As power is supplied from the power supply 130, the circuit board 113 may generate an RF signal or amplify the generated RF signal, and the radiation unit 30 may radiate electromagnetic waves to the accommodation space 112 to heat an aerosol generating article.

Also, the power supply 130 may be electrically or operatively connected to the controller 10 to supply the power necessary to control all operations of the aerosol generating device 1. In this case, the controller 10 may be implemented as a circuit element mounted on the circuit board 113 but may also be arranged as an independent configuration separated from the circuit board 113 depending on embodiments.

The controller 10 may measure a temperature of the material 200 and detect the temperature of an aerosol generating article based on the measurement result. For example, the controller 10 may measure the temperature of the material 200 by using the temperature sensor 210 around the material 200 and detect the temperature of the aerosol generating article based on the temperature of the material 200. In this case, the temperature sensor 210 may be in contact with or adjacent to the material 200.

In one example, the controller 10 may measure the temperature of the material 200 by using the temperature sensor 210, and detect the temperature of the aerosol generating article by using a lookup table in which the temperature of the material 200 matches the temperature of the aerosol generating article. Specifically, the controller 10 may measure the temperature of the material 200 by using the temperature sensor 210, and then detect the temperature of the aerosol generating article that matches the measured temperature of the material 200 by using a lookup table stored in memory.

In another example, the controller 10 may measure a temperature of the material 200 by using the temperature sensor 210, and detect a temperature of an aerosol generating article by using a correlation between the temperature of the material 200 and the temperature of the aerosol generating article. Specifically, the controller 10 may measure the temperature of the material 200 by using the temperature sensor 210, and then input the measured temperature of the material 200 into the correlation stored in memory to calculate the temperature of the aerosol generating article.

The aerosol generating device 1 of the disclosure may detect the temperature of an aerosol generating article by measuring the temperature of the material 200. That is, the aerosol generating device 1 of the disclosure may measure and control the temperature of an aerosol generating article more accurately by measuring the temperature of the material 200.

The controller 10 may control the power supplied to the circuit board 113 based on a temperature of the material 200. For example, the controller 10 may control the power supplied to the circuit board 113 such that the temperature of the material 200 follows a first temperature profile that is stored previously. In the disclosure, the first temperature profile may refer to a temperature change of the material 200 for effectively heating an aerosol generating article.

Because the temperature of the material 200 has a certain correlation with the temperature of an aerosol generating article, when the material 200 generates heat according to the first temperature profile, the aerosol generating article also generates heat according to a temperature profile having a similar trend to the first temperature profile.

Accordingly, the controller 10 may effectively heat an aerosol generating article by controlling the power supplied to the circuit board 113 such that the temperature of the material 200 follows the first temperature profile.

In another example, the controller 10 may control the power supplied to the circuit board 113 based on the temperature of the material 200 such that an aerosol generating article generates heat according to a second temperature profile that is stored previously. In the disclosure, the second temperature profile may refer to the most appropriate temperature change of an aerosol generating article for forming a high-quality aerosol.

The controller 10 may measure a temperature of the material 200 by using the temperature sensor 210 and detect the temperature of an aerosol generating article based on the measured temperature. The controller 10 may control the power supplied to the circuit board 113 such that the detected temperature of the aerosol generating article follows the second temperature profile. Accordingly, the controller 10 may improve quality of the aerosol generated by the aerosol generating device 1.

In another example, the controller 10 may stop the power supplied to inner components (for example, the circuit board 113, the radiation unit 30, and so on) of the aerosol generating device 1 when the temperature of the material 200 is higher than a threshold temperature. In the disclosure, the threshold temperature may refer to the highest temperature of the material 200 at which the inner components of the aerosol generating device 1 may maintain a normal operation environment.

The controller 10 may prevent the inner components of the aerosol generating device 1 from malfunctioning or being damaged due to thermal or electrical overload by controlling the power supplied to the circuit board 113 such that the temperature of the material 200 is not heated above the threshold temperature.

The aerosol generating device 1 of the disclosure may control the power supplied to the inner components of the aerosol generating device 1 based on the temperature of the material 200. That is, the aerosol generating device 1 of the disclosure may more precisely control the power supplied to the inner components of the aerosol generating device 1 by using the temperature of the material 200, and accordingly, quality of an aerosol and performance of the aerosol generating device 1 may be improved, and furthermore, the safety of a user may be ensured.

Although FIG. 2 illustrates only a structure in which the radiation unit 30 surrounds at least part of an outer circumferential surface of the accommodation space 112 and the material 200 and the temperature sensor 210 surround at least part of a bottom surface of the accommodation space 112, a relative arrangement structure between the radiation unit 30, the material 200, and the temperature sensor 210 is not limited thereto.

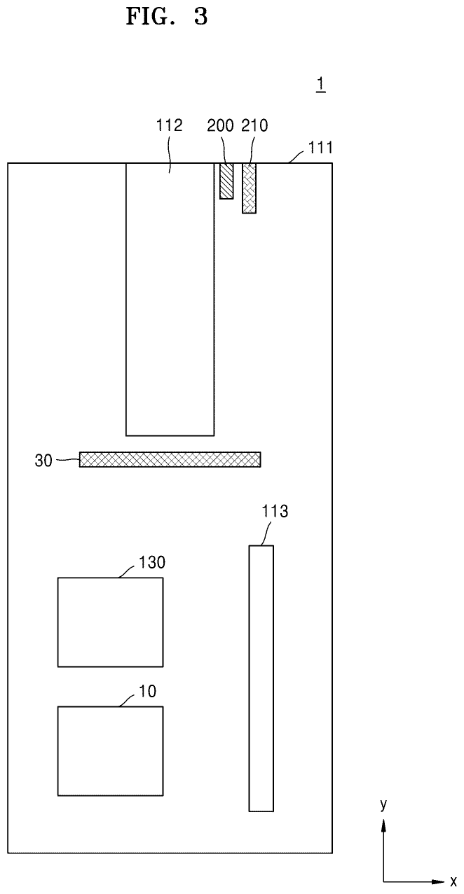

In another example, the material 200 and the temperature sensor 210 may also surround at least part of an outer circumferential surface of the accommodation space 112, and the radiation unit 30 may also surround at least part of a bottom surface of the accommodation space 112. FIG. 3 is a view illustrating an arrangement structure between the radiation unit 30, the material 200, and the temperature sensor 210 of FIG. 2.

Referring to FIG. 3, the radiation unit 30 may be around a lower portion (for example, a portion in the −x-axis direction) of an accommodation space 112, and the material 200 may be around an upper portion (for example, a portion in the +x-axis direction) of the accommodation space 112.

For example, the radiation unit 30 may be in contact with at least one region of the lower portion of the accommodation space 112 or may be close to the lower portion of the accommodation space 112, and the material 200 may be in contact with one region of the upper portion of the accommodation space 112 or may be close to the upper portion of the accommodation space 112. In this case, the temperature sensor 210 may be around the material 200 to measure a temperature of the material 200, and accordingly, the temperature sensor 210 may be around an upper portion of the accommodation space 112.

The radiation unit 30 may radiate electromagnetic waves toward the accommodation space 112. The electromagnetic waves radiated from the radiation unit 30 may be transmitted to an aerosol generating article accommodated in the accommodation space 112 and the material 200 around the accommodation space 112, and accordingly, the aerosol generating article and the material 200 may generate heat together.

The controller 10 may measure a temperature of the material 200 by using the temperature sensor 210, and based on the temperature of the material 200, the controller 10 may more accurately detect the temperature of an aerosol generating article and more precisely control the power supplied to inner components of the aerosol generating device 1.

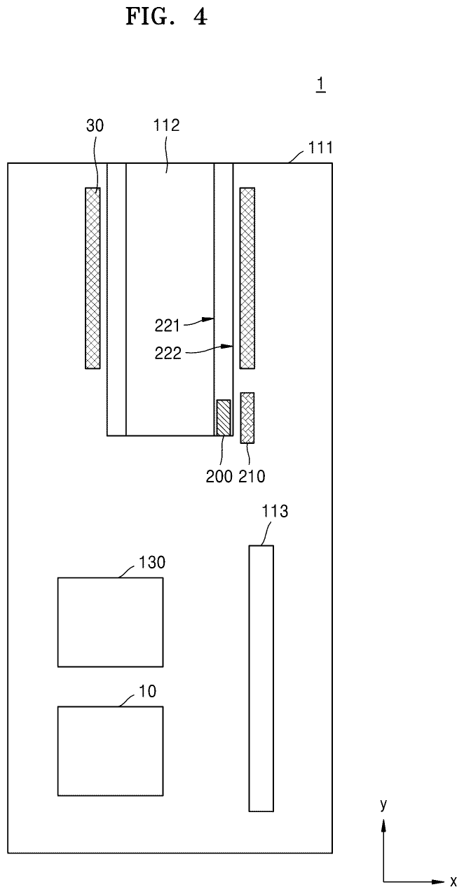

FIG. 4 is a cross-sectional view of an aerosol generating device 1 according to another embodiment. The aerosol generating device 1 according to another embodiment may be an aerosol generating device that differs only in structure of the accommodation space 112 and arrangement structure of the material 200 and the temperature sensor 210 from the aerosol generating device 1 according to an embodiment described above with reference to FIG. 2, and redundant descriptions thereof are omitted below.

Referring to FIG. 4, the aerosol generating device 1 (for example, the aerosol generating device 1 of FIGS. 1 to 3) according to another embodiment may include a housing 111 (for example, the housing 111 of FIGS. 2 and 3), a circuit board 113 (for example, the circuit board 113 of FIGS. 2 and 3), a radiation unit 30 (for example, the radiation unit 30 of FIGS. 2 and 3), a material 200 (for example, the material 200 of FIGS. 2 and 3), a temperature sensor 210 (for example, the temperature sensor 210 of FIGS. 2 and 3), a power supply 130 (for example, the power supply 130 of FIGS. 1 to 3), and a controller 10 (for example, the controller 10 of FIGS. 1 to 3).

In the aerosol generating device 1 according to another embodiment, an accommodation space 112 may have a cylindrical shape including an inner surface and an outer surface. That is, the accommodation space 112 may have a dual structure. The inner surface may surround at least part of the aerosol generating article accommodated in the accommodation space 112, and the outer surface may surround the inner surface. In t his case, the inner surface may be separated from the outer surface, and accordingly, a separation space (or an interspace) may be formed between the inner surface and the outer surface.

For example, the inner surface may include an inner circumferential surface 221, and the outer surface may include an outer circumferential surface 222. The inner circumferential surface 221 of the accommodation space 112 may surround at least part of an outer circumferential surface of an aerosol generating article accommodated in the accommodation space 112, and the outer circumferential surface 222 of the accommodation space 112 may surround the inner circumferential surface 221 of the accommodation space 112. As a result, a side space may be formed between the inner circumferential surface 221 of the accommodation space 112 and the outer circumferential surface 222 of the accommodation space 112.

The material 200 may be between the inner surface of the accommodation space 112 and the outer surface thereof. For example, the material 200 may be between the inner circumferential surface 221 of the accommodation space 112 and the outer circumferential surface 222 of the accommodation space 112. That is, the material 200 may be in a side space formed between the inner circumferential surface 221 of the accommodation space 112 and the outer circumferential surface 222 of the accommodation space 112. In this case, the temperature sensor 210 may be outside the accommodation space 112 and be in a position close to the material 200.

When an aerosol generating article is heated by the electromagnetic waves radiated from the radiation unit 30 to the accommodation space 112, resonance of the electromagnetic waves has to occur within the accommodation space 112 to greatly increase the heating efficiency of the aerosol generating article. That is, as a frequency of the RF signal generated by the circuit board 113 corresponds to or approaches a resonance condition (for example, a resonance frequency) of the accommodation space 112, the heating efficiency of an aerosol generating article may be increased.

Because the material 200 emits heat in response to the electromagnetic waves radiated from the radiation unit 30, when the material 200 is inside the accommodation space 112, the material 200 may affect a resonance condition of the accommodation space 112, and accordingly, the heating efficiency of an aerosol generating article may be reduced.

Although the material 200 is inside the accommodation space 112, the material 200 is between the inner circumferential surface 221 of the accommodation space 112 and the outer circumferential surface 222 of the accommodation space 112, and accordingly, the material 200 may generate heat according to the same electromagnetic wave as the electromagnetic wave radiated to an aerosol generating article, and may not affect the resonance condition of the accommodation space 112.

According to the aerosol generating device 1 of the disclosure, the material 200 is between the inner circumferential surface 221 of the accommodation space 112 and the outer circumferential surface 222 of the accommodation space 112, and accordingly, the temperature of an aerosol generating article may be measured more accurately and controlled more precisely based on the temperature of the material 200, and heating efficiency of the aerosol generating device 1 may be maintained stably.

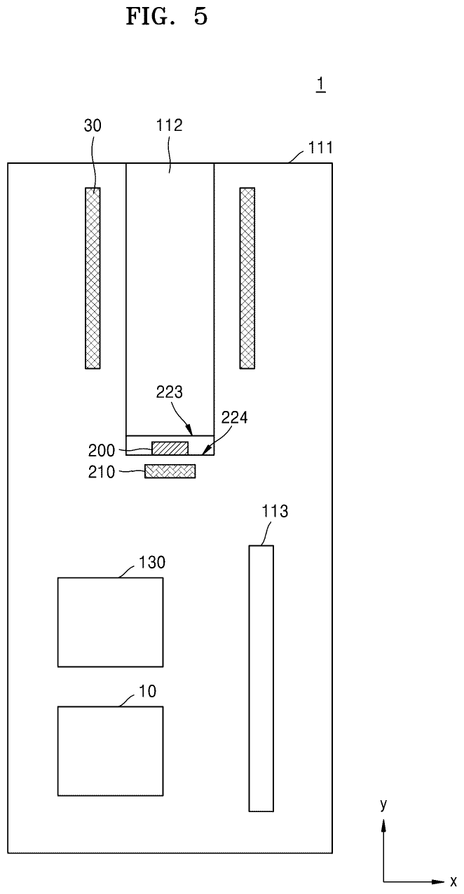

FIG. 5 is a cross-sectional view of an aerosol generating device 1 according to another embodiment. The aerosol generating device 1 according to another embodiment may be an aerosol generating device that differs only in structure of the accommodation space 112 and arrangement structures of the material 200 and the temperature sensor 210 from the aerosol generating device 1 according to an embodiment described above with reference to FIG. 2, and redundant descriptions thereof are omitted below.

Referring to FIG. 5, the aerosol generating device 1 according to another embodiment (for example, the aerosol generating device 1 of FIGS. 1 to 4) may include a housing 111 (for example, the housing 111 of FIGS. 2 to 4), a circuit board 113 (for example, the circuit board 113 of FIGS. 2 to 4), a radiation unit 30 (for example, the radiation unit 30 of FIGS. 2 to 4), a material 200 (for example, the material 200 of FIGS. 2 to 4), a temperature sensor 210 (for example, the temperature sensor 210 of FIGS. 2 to 4), a power supply 130 (for example, the power supply 130 of FIGS. 1 to 4), and a controller 10 (for example, the controller 10 of FIGS. 1 to 4).

In the aerosol generating device 1 according to another embodiment, an accommodation space 112 may have a cylindrical shape including an inner surface and an outer surface. That is, the accommodation space 112 may have a dual structure. The inner surface may surround at least part of the aerosol generating article accommodated in the accommodation space 112, and the outer surface may surround the inner surface. In t his case, the inner surface may be separated from the outer surface, and accordingly, a separation space (or an interspace) may be formed between the inner surface and the outer surface.

However, unlike that illustrated in FIG. 4, the inner surface may include an inner bottom surface 223, and the outer surface may include an outer bottom surface 224. The inner bottom surface 223 may be in contact with one end of the aerosol generating article accommodated in the accommodation space 112, and the outer bottom surface 224 may be separated from the inner bottom surface 223 and face the inner bottom surface 223. As a result, a low space may be formed between the inner bottom surface 223 and the outer bottom surface 224.

The material 200 may be between the inner surface of the accommodation space 112 and the outer surface thereof. For example, the material 200 may be between the inner bottom surface 223 and the outer bottom surface 224. That is, the material 200 may be in the low space formed between the inner bottom surface 223 and the outer bottom surface 224. In this case, the temperature sensor 210 may be outside the accommodation space 112 and close to the material 200.

When an aerosol generating article is heated by the electromagnetic waves radiated from the radiation unit 30 to the accommodation space 112, resonance of the electromagnetic waves has to occur within the accommodation space 112 to greatly increase the heating efficiency of the aerosol generating article. That is, as a frequency of the RF signal generated by the circuit board 113 corresponds to or approaches a resonance condition (for example, a resonance frequency) of the accommodation space 112, the heating efficiency of an aerosol generating article may be increased.

Because the material 200 emits heat in response to the electromagnetic waves radiated from the radiation unit 30, when the material 200 is inside the accommodation space 112, the material 200 may affect a resonance condition of the accommodation space 112, and accordingly, the heating efficiency of an aerosol generating article may be reduced.

Although the material 200 is inside the accommodation space 112, the material 200 is between the inner bottom surface 223 of the accommodation space 112 and the outer bottom surface 224 of the accommodation space 112, and accordingly, the material 200 may generate heat according to the same electromagnetic wave as the electromagnetic wave radiated to an aerosol generating article, and may not affect the resonance condition of the accommodation space 112.

According to the aerosol generating device 1 of the disclosure, the material 200 is between the inner bottom surface 223 and the outer bottom surface 224, and accordingly, the temperature of an aerosol generating article may be measured more accurately and controlled more precisely based on the temperature of the material 200, and heating efficiency of the aerosol generating device 1 may be maintained stably.

According to an embodiment, an aerosol generating device may include a housing including an accommodation space for accommodating at least part of an aerosol generating article, a circuit board located in the housing and configured to generate an RF signal, a radiation unit located in the housing and configured to heat the aerosol generating article accommodated in the accommodation space by radiating the RF signal in the form of an electromagnetic wave toward the aerosol generating article, a material arranged adjacent to the accommodation space and configured to generate heat according to the radiated electromagnetic wave, and a controller configured to measure a temperature of the material and detect a temperature of the aerosol generating article based on a measured temperature of the material.

In one example, the accommodation space may have a cylindrical shape with an inner surface and an outer surface, the inner surface may surround at least part of the aerosol generating article accommodated in the accommodation space, the outer surface may surround the inner surface, and the material may be arranged between the inner surface and the outer surface.

In this case, the inner surface may include an inner circumferential surface, the outer surface may include an outer circumferential surface, and the material may be arranged in a side space between the inner circumferential surface and the outer circumferential surface.

Alternatively, the inner surface may include an inner bottom surface, the outer surface may include an outer bottom surface, and the material may be arranged in a low space between the inner bottom surface and the outer bottom surface.

The aerosol generating device may further include memory storing a lookup table in which the temperature of the material matches the temperature of the aerosol generating article, and the controller may detect the temperature of the aerosol generating article matching the measured temperature of the material by using the lookup table.

Alternatively, the aerosol generating device may further include memory storing a correlation between the temperature of the material and the temperature of the aerosol generating article, and the controller may calculate the temperature of the aerosol generating article by inputting the measured temperature of the material to the correlation.

For example, the controller may control power supplied to the circuit board such that the temperature of the material follows a first temperature profile that is stored previously.

In another example, the controller may control power supplied to the circuit board such that the aerosol generating article generates heat, based on the temperature of the material, according to a second temperature profile that is stored previously.

In another example, the controller may stop power supplied to the circuit board when the temperature of the material is greater than a threshold temperature that is stored previously.

The aerosol generating article may include vegetable glycerin, and the material may be metal that generates heat in response to an electromagnetic wave of 2.45 GHz applied thereto.

For example, the material may include at least one of nickel-zinc (Ni—Zn) ferrite, manganese-zinc (Mn—Zn) ferrite, carbon black, carbon nanotube (CNT), graphene, iron (ferrous material), nickel, cobalt, manganese oxide (MnO₂), titanium oxide (TiO₂), nickel oxide (NiO), barium titanate (BaTiO₃), and silicon carbide (SiC).

The aerosol generating device may further include a temperature sensor arranged around the material and configured to measure the temperature of the material.

Aerosol generating devices according to various embodiments of the disclosure may indirectly detect the temperature of an aerosol generating article by using a material that generates heat together with the aerosol generating article.

Aerosol generating devices according to various embodiments of the disclosure may more accurately measure and control the temperature of an aerosol generating article, and accordingly, the quality of the aerosol and the performance of the aerosol generating device may be improved, and furthermore, the safety of a user may be ensured.

The effects of the embodiments are not limited to the effects described above, and effects not mentioned can be clearly understood by a person having ordinary skill in the art to which the embodiments belong from this specification and the attached drawings.

Any of the embodiments or other embodiments of the present disclosure described above are not mutually exclusive or distinct. Any of the embodiments or other embodiments of the present disclosure described above may be combined or combined in their respective configurations or functions.

For example, it means that the A configuration described in a specific embodiment and/or the drawings and the B configuration described in another embodiment and/or the drawings may be combined. That is, even if the combination between the configurations is not directly described, it means that the combination is possible, except in cases where the combination is described as impossible.

The above detailed description should not be construed as limiting in all respects, but should be considered as illustrative. The scope of the present disclosure should be determined by a reasonable interpretation of the appended claims, and all changes within the equivalent scope of the present disclosure are included in the scope of the present disclosure.

What is claimed is:

1. An aerosol generating device comprising:
a housing including an accommodation space for accommodating at least part of an aerosol generating article;
a circuit board located in the housing and configured to generate a radio frequency (RF) signal;
a radiation unit located in the housing and configured to heat the aerosol generating article accommodated in the accommodation space by radiating the RF signal in a form of an electromagnetic wave toward the aerosol generating article;
a material arranged adjacent to the accommodation space and configured to generate heat according to the radiated electromagnetic wave; and
a controller configured to measure a temperature of the material and detect a temperature of the aerosol generating article based on a measured temperature of the material.

2. The aerosol generating device of claim 1, wherein
the accommodation space has a cylindrical shape with an inner surface and an outer surface,
the inner surface surrounds at least part of the aerosol generating article accommodated in the accommodation space,
the outer surface surrounds the inner surface, and
the material is arranged between the inner surface and the outer surface.

3. The aerosol generating device of claim 2, wherein
the inner surface includes an inner circumferential surface,
the outer surface includes an outer circumferential surface, and
the material is arranged in a side space between the inner circumferential surface and the outer circumferential surface.

4. The aerosol generating device of claim 2, wherein
the inner surface includes an inner bottom surface,
the outer surface includes an outer bottom surface, and
the material is arranged in a low space between the inner bottom surface and the outer bottom surface.

5. The aerosol generating device of claim 1, further comprising memory storing a lookup table in which the temperature of the material matches the temperature of the aerosol generating article,
wherein the controller is further configured to detect the temperature of the aerosol generating article matching the measured temperature of the material by using the lookup table.

6. The aerosol generating device of claim 1, further comprising memory storing a correlation between the temperature of the material and the temperature of the aerosol generating article,
wherein the controller is further configured to calculate the temperature of the aerosol generating article by inputting the measured temperature of the material to the correlation.

7. The aerosol generating device of claim 1, wherein the controller is further configured to control power supplied to the circuit board such that the temperature of the material follows a first temperature profile that is stored previously.

8. The aerosol generating device of claim 1, wherein the controller is further configured to control power supplied to the circuit board such that the aerosol generating article generates heat, based on the temperature of the material, according to a second temperature profile that is stored previously.

9. The aerosol generating device of claim 1, wherein the controller is further configured to stop power supplied to the circuit board when the temperature of the material is greater than a threshold temperature that is stored previously.

10. The aerosol generating device of claim 1, wherein
the aerosol generating article includes vegetable glycerin, and
the material is metal that generates heat in response to an electromagnetic wave of 2.45 GHz applied thereto.

11. The aerosol generating device of claim 1, wherein the material includes at least one of nickel-zinc (Ni—Zn) ferrite, manganese-zinc (Mn—Zn) ferrite, carbon black, carbon nanotube (CNT), graphene, iron (ferrous material), nickel, cobalt, manganese oxide (MnO₂), titanium oxide (TiO₂), nickel oxide (NiO), barium titanate (BaTiO₃), and silicon carbide (SiC).

12. The aerosol generating device of claim 1, further comprising a temperature sensor arranged around the material and configured to measure the temperature of the material.
